(19) United States
(12) Patent Application Publication
(10) Pub. No.: US 2024/0301896 A1
(43) Pub. Date: Sep. 12, 2024

(54) PISTON FOR A BRAKE CALIPER

(71) Applicant: Divergent Technologies, Inc., Los Angeles, CA (US)

(72) Inventors: Marco PAGNI, Los Angeles, CA (US); Claudio Alberto CAPRARELLA, Los Angeles, CA (US)

(21) Appl. No.: 18/601,856

(22) Filed: Mar. 11, 2024

Related U.S. Application Data
(60) Provisional application No. 63/451,516, filed on Mar. 10, 2023.

(51) Int. Cl. F15B 15/14; F16D 65/16; F16D 125/06

(52) U.S. Cl. CPC F15B 15/1447; F16D 65/16; F16D 2125/06; F16D 2200/003; F16D 2250/00

(57) ABSTRACT

Disclosed herein are pistons for transferring a force perpendicular to a length of a cylinder in which the piston is arranged. The pistons may include an outer structure including a piston face configured to transfer the force, a piston wall configured to align parallel with and proximate to a cylinder wall of the cylinder, and the piston face and piston wall defining an internal volume of the piston. Further, the pistons may also include a inner structure. The outer and inner structures can bound hollow spaces within the piston. The inner structure can also include a discharge hole or a pair of intersecting crossing members.

### CROSS-REFERENCE TO RELATED APPLICATION

This application the benefit of, and right of priority to, U.S. Patent Application No. 63/451,516, entitled “Piston for a Brake Caliper,” filed Mar. 10, 2023, the contents of which are expressly incorporated by reference as if fully set forth herein.

### BACKGROUND

### Field

The present disclosure relates generally to braking structures, and more specifically to brake caliper pistons.

### Background

Brake assemblies typically include a brake caliper with a piston bore that is adapted to support a brake piston. Brake pistons can move a brake pad against a moving component to create a clamping force that may be used to slow, stop, or prevent movement of the moving component. Brake pistons for a caliper are required in braking systems to support high hydraulic pressure and low axial compliance to meet stringent brake stiffness and pedal feel requirements.

Typically, these components are designed as hollow cylindrical shapes and produced from bar stocks by means of computer numerical control (CNC) machining. Production cost is the primary driver for such design and high margins of improvement are possible to create an alternative architecture that is more structurally efficient. For example, brake pistons are often manufactured from raw material like titanium alloys that provide structural integrity but are expensive. Additionally, the more raw material that is used, the heavier the piston will be.

Accordingly, there is a need for a brake piston that reduces the amount of raw material used in manufacture while maintaining or improving the stiffness to mass ratio of the piston.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In one aspect of the disclosure, a piston for transferring a force perpendicular to a length of a cylinder in which the piston is arranged is provided. In one or more embodiments, the piston includes an outer structure including a piston face configured to transfer the force, a piston wall and a first inner surface. For example, the piston wall can be configured to align parallel with and proximate to a cylinder wall of the cylinder such that the piston face and piston wall define an internal volume of the piston, and the first inner surface bounds a first portion of a first hollow space within the internal volume. Further, in one more embodiments, the piston face is configured to transfer, to a brake pad, the force from hydraulic pressure applied within the internal volume of the piston. For example, the hydraulic pressure in the first hollow space and a hydraulic pressure in a second hollow space are approximately the same. In one or more embodiments, the outer structure is circularly cylindrical. Further, in one more embodiments, the piston face is configured to transfer, to a piston rod connected to the piston, the force from an internal combustion applied to the piston face.

In one or more embodiments, the piston includes an inner structure. For example, the inner structure can include a second inner surface bounding a second hollow space within the outer structure and an outer surface bounding a second portion of the first hollow space. Additionally, a portion of the inner structure can bound a discharge hole. The discharge hole can pass through the inner structure. In one or more embodiments, the inner structure is conical. Further, the inner structure can include one or more connection points to the first inner surface of the outer structure. For example, the inner structure can include at least three connection points to the first inner surface of the outer structure.

In one or more embodiments, the piston is additively manufactured.

In one or more embodiments, the piston includes titanium.

In one or more embodiments, the piston has a mass of less than 50 g.

In one or more embodiments, a width of the outer structure of the piston is between 10 and 15 mm.

In one or more embodiments, the piston includes a pair of intersecting crossing members extending from the second inner surface.

In another aspect of the disclosure, a piston for transferring a force perpendicular to a length of a cylinder in which the piston is arranged is provided. In one or more embodiments, the piston includes an outer structure including a piston face configured to transfer the force, a piston wall configured to align parallel with and proximate to a cylinder wall of the cylinder, the piston face and piston wall defining an internal volume of the piston, and an inner surface within the internal volume. In one or more embodiments, the piston face is configured to transfer, to a brake pad, the force from hydraulic pressure applied within the internal volume of the piston. In one or more embodiments, the piston face is configured to transfer, to a piston rod connected to the piston, the force from an internal combustion applied to the piston face.

Further, in one or more embodiments, the piston includes a inner structure including a pair of intersecting crossing members extending from the inner surface of the outer structure, in which the inner surface of the outer structure and an outer surface of each crossing member bound one or more hollow spaces. For example, the crossing members can be arranged perpendicularly to one another. In one or more embodiments, a portion of the inner structure bounds a discharge hole. For example, the discharge hole passes through the inner structure.

In one or more embodiments, the piston is additively manufactured using titanium.

In one or more embodiments, the piston has a mass of less than 50 g.

It is understood that other aspects will become readily apparent to those skilled in the art from the following detailed description, wherein various aspects of apparatuses and methods are shown and described by way of illustration. As will be realized, these aspects may be implemented in other and different forms and its several details are capable of modification in various other respects. Accordingly, the drawings and detailed description are to be regarded as illustrative in nature and not as restrictive.

### BRIEF DESCRIPTION OF THE DRAWINGS

Various aspects of the concepts described herein will now be presented in the detailed description by way of example, and not by way of limitation, in the accompanying drawings, wherein:

FIG. 1 illustrates a cutaway side view of a conventional brake piston.

FIGS. 2A-2C illustrate perspective, bottom, and side views of an exemplary brake piston according to one or more embodiments disclosed herein.

FIGS. 2D-2E illustrate perspective and side cutaway views of an exemplary brake piston of FIGS. 2A-2C according to one or more embodiments disclosed herein.

FIG. 3 illustrates a perspective view of an exemplary brake piston according to one or more embodiments disclosed herein.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

Disclosed herein are embodiments directed to pistons for use in hydraulic brake calipers, and in particular, high performance hydraulic brake calipers. In order to provide such high performance, the piston structure is optimized to reduce the amount of raw material used in manufacture while maintaining or improving the stiffness to mass ratio of the piston. These pistons have reinforced architectures that include an outer structure (or shell) and an inner structure (or body) that are designed to promote structure integrity and mass optimization to the piston. The pistons disclosed herein have complex structures. As such, the pistons may be produced by means of additive manufacturing—i.e., three-dimensional printing. Additive manufacturing techniques permit pistons to be manufactured using less material than conventional processes. Whereas conventional processes remove portions of a solid amount of raw material using tools such as a lathe to produce the desired piston design, thereby wasting unused raw material, additive manufacturing techniques can use only the amount of material necessary to form the completed piston because the internal portions of the piston do not need to be separately machined.

For example, the pistons disclosed herein can be additively manufactured using such techniques as laser-based powder bed fusion, direct metal laser sintering, selective laser melting and selective laser sintering (SLS). Still other additive manufacturing processes to which the principles of this disclosure are pertinent include those that are currently contemplated or under commercial development. While the specific details of each such process are omitted to avoid unduly obscuring key concepts of the disclosure, it will be appreciated that the disclosure herein is intended to encompass such techniques and related structures.

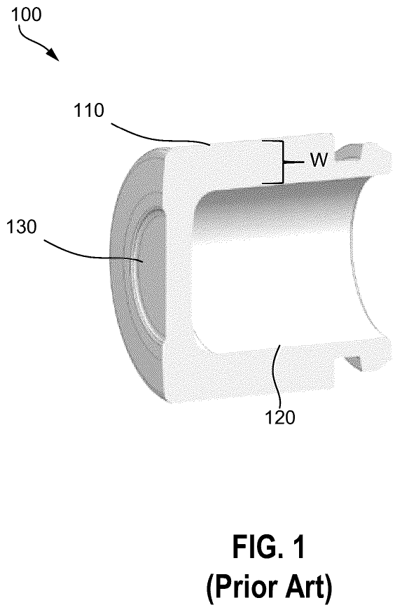

The piston embodiments disclosed herein are more optimized as compared to conventional pistons formed by, for example, automatic lathes. In order to mass produce conventional pistons having a desired structural integrity by such methods, the walls of conventional pistons are thick and consist of uniform designs configured to receive piston or connecting rods. Such conventional piston designs typically have U-shaped designs, as shown by FIG. 1. FIG. 1 illustrates a longitudinal bisected cutaway view of a conventional piston 100. The piston 100 is rotationally symmetric along the cutaway view. The piston 100 has an outer surface 110, an inner surface 120, and a piston face 130 arranged to transfer force generated by the piston. The outer surface 110 and the inner surface 120 are separated by a width W and form the interior U-shape for receiving a piston rod (not shown). For example, the width W may be more than 15 mm, 20 mm, or larger. Such a design is structurally inefficient, as the width W of the piston 100 requires substantial raw material, and is not configured to provide optimal stiffness to mass ratios.

In contrast, it is an aim of the embodiments disclosed herein to provide brake pistons in which the structural design is optimized to reduce the material needed to manufacture the piston, but still maintain desired stiffness to mass ratios. In one or more embodiments, the pistons disclosed herein include two main sections: a cylindrical-shaped outer structure (i.e., a shell) and a inner structure forming an internal body. The outer structure includes less material than that of conventional pistons (e.g., piston 100) and a correspondingly smaller width. For example, the material comprising the outer structure may amount to 40-49%, 50-59%, 60-69%, 70-79%, 80-89%, or 90-99% of the mass of the material that comprises width W of piston 100. In one or more embodiments, the width of the outer structure of the pistons contemplated herein is less than 15 mm, and may be less than 10 mm. In one or more embodiments, the outer structure includes a mass between 31-40 g, 41-50 g, 51-60 g, or 61-70 g.

In one or more embodiments, the inner structure of the piston is a conical or cone-shaped inner core body. The cone-shape provides structural integrity along a longitudinal axial direction of the piston and supports the mechanical load that the piston is subjected to during use. In one or more embodiments, the inner structure includes one or more connection points with the inner surface of the outer structure. For example, the inner structure may include a connection point at the inner surface of the outer structure adjacent to the center of the piston face. In one or more embodiments, the inner structure has at least three connection points with the inner surface of the outer structure. For example, the inner structure can include connection points at the inner surface of the outer structure adjacent to the center of the piston face and at the piston wall.

In one or more embodiments, the inner structure of the piston includes one or more crossing members extending from the inner surface of the outer structure. The crossing members may bound one or more hollow spaces within the piston to provide radial stiffness to the piston. For example, the crossing members may be arranged perpendicularly to one another to provide the largest support to the inner structure of the piston. However, the crossing members are not required to be arranged perpendicularly to one another, and may be arranged at any angle to one another in order to achieve the purposes disclosed herein.

In one or more embodiments, the piston includes a diaphragm within the inner structure. A diaphragm internal to the piston may increase radial stiffness of the structure. For example, the diaphragm can be a circumferential disc shaped component that is in a hollow space between the outer and inner structures.

In one or more embodiments, the piston includes one or more discharge holes. Discharge holes may serve to maintain constant ambient pressure within the inner structure of the piston through the different temperature conditions that the piston may face during operation. For example, the inner surface of the inner structure may include discharge holes that open the hollow portion within the inner structure to a hollow portion between the inner structure and the outer structure to maintain constant pressure between the hollow portions of each structure. Discharge holes may be symmetrically or asymmetrically arranged within the inner structure. In an embodiment, the piston includes three discharge holes.

With reference now to FIG. 1, FIG. 1 illustrates a conventional piston 100. Conventional pistons like this are formed from blocks of raw material that are machined by tools such as lathes to define an U-shaped hollow inner portion arranged to receive a conventional piston rod. The piston 100 includes an outer surface 110 and an inner surface 120 that are separated by a width W. A piston face 130 is arranged toward a brake pad (not shown), which receives force generated by hydraulic pressure applied within the internal volume of the piston. As shown, the piston 100 includes a wide outer structure having additional mass that is not strictly necessary for the function of the piston. That is, the structural stiffness of piston 100 relies upon the material comprising the width W of the piston 100.

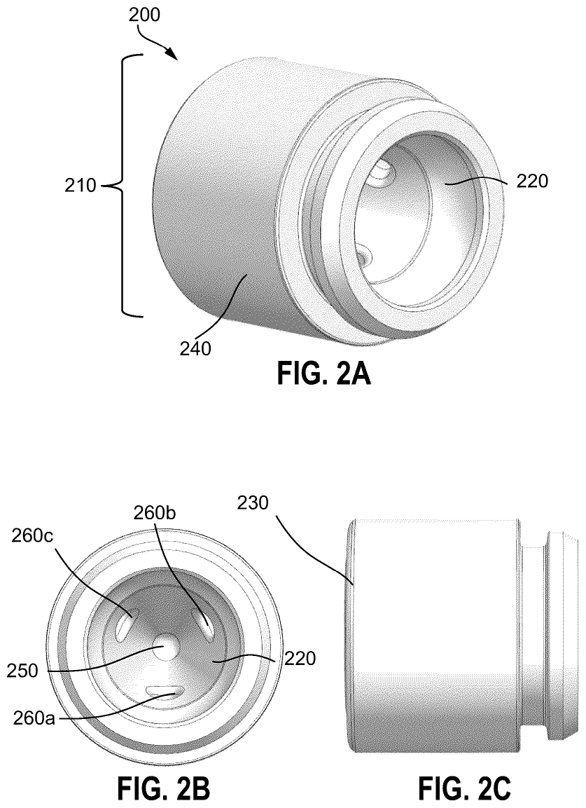

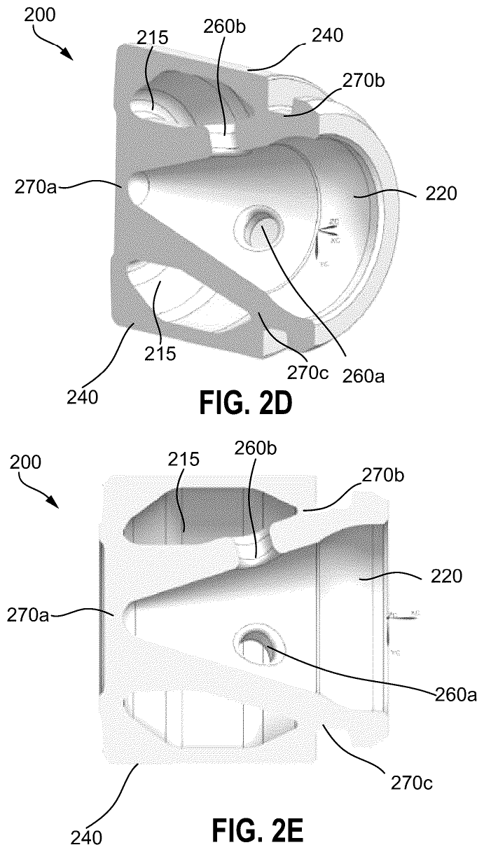

With reference now to FIGS. 2A-2E, an exemplary brake piston 200 according to one or more embodiments disclosed herein is provided. The piston 200 includes an outer structure 210 and an inner structure 220. The outer structure includes a piston face 230 configured to transfer a force generated by the piston to a piston rod and/or a brake pad in a braking assembly and a piston wall 240 configured to align parallel with and proximate to a cylinder wall of a cylinder in which the piston 200 is arranged. Together, the piston face 230 and piston wall 240 define an internal volume of the piston. The inner surface of the outer structure 210 bounds at least a portion of a hollow space 215 within this internal volume. For example, the hollow space 215 may be a circumferential portion of space that extends around the perimeter of the internal volume of the piston 200. In other embodiments, the hollow space 215 is a discrete portion of the internal volume of the piston 200. While the outer structure 210 is illustrated as circularly cylindrical, the outer structure is not limited to being circularly cylindrical, as other shapes may be contemplated according to the piston design sought.

The inner structure 220 of the piston 200 defines a cone-shaped inner core body that is widest near the base of the piston and narrows toward the piston face 230 to an inner peak 250. The outer surface of the inner structure 220 bounds at least a portion of the hollow space within the internal volume captured by the outer structure. In other words, the inner surface of the outer structure 210 and the outer surface of the inner structure 220 bound at least portions of hollow space between the outer and inner structures. In one or more embodiments, the hollow space bound by the outer and inner structures is the same. However, the outer and inner structures may bound multiple hollow spaces, or there may be intervening structures within or adjacent to the hollow spaces that further subdivide the internal volume of the piston, such as a diaphragm.

Along the surface of the inner structure 220 are one or more discharge holes 260a, 260b, 260c. These discharge holes 260 permit the free flow of air between the hollow space defined by the inner surface of the inner structure 220 and the hollow space within an internal volume of the outer structure 210. In this way, the hydraulic pressure in each of the hollow spaces within the piston 200 may be approximately the same during operation. The discharge holes 260 are illustrated as being circular, though other shapes such as oblongs, rectangles, or other geometric shapes may be implemented depending on the piston design sought.

In one or more embodiments, the piston 200 may further include a pair of intersecting crossing members extending from the inner surface of the inner structure. The crossing members can be arranged perpendicularly to one another, or may be arranged symmetrically or asymmetrically from one another at different angles depending on the piston design sought.

With specific reference to FIGS. 2D and 2E, the inner structure 220 may also include one or more connection points 270 to the inner surface of the outer structure 210. Connection points 270 can include portions of the inner structure 220 that abut, contact, or are adjacent to the outer structure 210. For example, the inner structure 220 illustrated by FIGS. 2D-2E includes three connection points 270a, 270b, 270c. However, the embodiment illustrated by FIGS. 2D-2E is merely exemplary and does not imply that the piston 200 is required to have three connection points. Other piston configurations may have one, two, or more than three connection points depending on the structural stiffness and other material property considerations desired by the piston design.

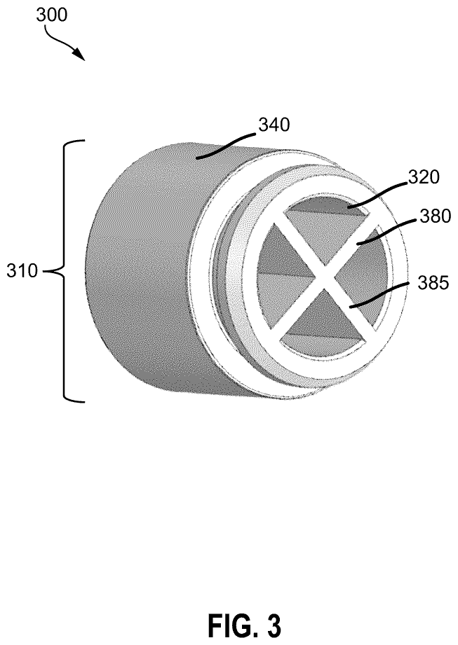

With reference now to FIG. 3, an exemplary brake piston 300 according to one or more embodiments disclosed herein is provided. The piston 300 includes an outer structure 310 and an inner structure 320. The outer structure includes a piston face (not shown) configured to transfer a force generated by the piston to a piston rod and/or a brake pad in a braking assembly and a piston wall 340 configured to align parallel with and proximate to a cylinder wall of a cylinder in which the piston 300 is arranged. Together, the piston face and piston wall define an internal volume of the piston.

The inner structure 320 of the piston 300 further includes a pair of crossing members 380, 385. The crossing members extend from, and extend longitudinally the length of, the inner surface of the outer structure 310 and intersect to bound hollow spaces within the inner structure. In one or more embodiments, the bound hollow spaces are equally sized. Additionally, the crossing members 380, 385 may be arranged perpendicularly to one another.

While the embodiment illustrated by FIG. 3 illustrates crossing members 380, 385 that are perpendicularly arranged and extend from opposite sides of the inner surface of the outer structure 310, additional variations of crossing member designs are contemplated by the disclosure herein. For example, the crossing members may be arranged at non-perpendicular angles, may be asymmetrically arranged from one another, may extend along less than the entire longitudinal length of the inner surface of the outer structure, or may extend from only one side of the inner surface of the outer structure. In one or more further embodiments, the piston may include more than two pair of crossing members. In one or more further embodiments, the crossing members are offset such that they do not intersect centrally.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other support structures and systems and methods for removal of support structures. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. A piston for transferring a force perpendicular to a length of a cylinder in which the piston is arranged, the piston comprising:
an outer structure including a piston face configured to transfer the force, a piston wall configured to align parallel with and proximate to a cylinder wall of the cylinder, the piston face and piston wall defining an internal volume of the piston, and a first inner surface bounding a first portion of a first hollow space within the internal volume; and
an inner structure including a second inner surface bounding a second hollow space within the outer structure, and an outer surface bounding a second portion of the first hollow space,
wherein a portion of the inner structure bounds a discharge hole.

2. The piston of claim 1, wherein the outer structure is circularly cylindrical.

3. The piston of claim 1, wherein the inner structure is conical.

4. The piston of claim 1, wherein the inner structure has one or more connection points to the first inner surface of the outer structure.

5. The piston of claim 4, wherein at least one of the one or more connection points is at the first inner surface of the piston face.

6. The piston of claim 4, wherein the inner structure has at least three connection points to the first inner surface of the outer structure.

7. The piston of claim 1, wherein the discharge hole passes through the inner structure.

8. The piston of claim 1, wherein the piston face is configured to transfer, to a brake pad, the force from hydraulic pressure applied within the internal volume of the piston.

9. The piston of claim 8, wherein a hydraulic pressure in the first hollow space and a hydraulic pressure in the second hollow space are approximately the same.

10. The piston of claim 1, wherein the piston is additively manufactured.

11. The piston of claim 1, wherein the piston comprises titanium.

12. The piston of claim 1, wherein the piston has a mass of less than 50 g.

13. The piston of claim 1, wherein a width of the outer structure is between 10 and 15 mm.

14. The piston of claim 1, further comprising a pair of intersecting crossing members extending from the second inner surface.

15. The piston of claim 1, wherein the piston face is configured to transfer, to a piston rod connected to the piston, the force from an internal combustion applied to the piston face.

16. A piston for transferring a force perpendicular to a length of a cylinder in which the piston is arranged, the piston comprising:
an outer structure including a piston face configured to transfer the force, a piston wall configured to align parallel with and proximate to a cylinder wall of the cylinder, the piston face and piston wall defining an internal volume of the piston, and an inner surface within the internal volume; and
a inner structure including a pair of intersecting crossing members extending from the inner surface of the outer structure,
wherein the inner surface of the outer structure and an outer surface of each crossing member bound one or more hollow spaces.

17. The piston of claim 16, wherein the crossing members are arranged perpendicularly to one another.

18. The piston of claim 16, wherein a portion of the inner structure bounds a discharge hole.

19. The piston of claim 18, wherein the discharge hole passes through the inner structure.

20. The piston of claim 16, wherein the piston is additively manufactured using titanium.

21. The piston of claim 16, wherein the piston has a mass of less than 50 g.

22. The piston of claim 16, wherein the piston face is configured to transfer, to a brake pad, the force from hydraulic pressure applied within the internal volume of the piston.

23. The piston of claim 16, wherein the piston face is configured to transfer, to a piston rod connected to the piston, the force from an internal combustion applied to the piston face.
